(19) United States
(12) Patent Application Publication
(10) Pub. No.: US 2022/0067583 A1
(43) Pub. Date: Mar. 3, 2022

(54) METHOD AND ELECTRONIC DEVICE FOR EVALUATING PERFORMANCE OF IDENTIFICATION MODEL

(71) Applicant: PEGATRON CORPORATION, Taipei City (TW)

(72) Inventor: Shih-Jen Chu, Taipei City (TW)

(73) Assignee: PEGATRON CORPORATION, Taipei City (TW)

(21) Appl. No.: 17/367,989

(22) Filed: Jul. 6, 2021

(30) Foreign Application Priority Data
Aug. 25, 2020 (TW) 109128906

(51) Int. Cl. G06N 20/00; G06K 9/62

(52) U.S. Cl. CPC G06N 20/00; G06K 9/6262; G06K 9/6256

(57) ABSTRACT

A method and an electronic device for evaluating a performance of an identification model are provided. The method includes: obtaining a source data sample, a plurality of test samples, and a target data sample; inputting the plurality of test samples into a pre-trained model trained based on the source data sample to obtain a normal sample and an abnormal sample; converting the source data sample to generate a converted source data sample, converting the normal sample to generate a converted normal sample, and converting the abnormal sample to generate a converted abnormal sample; adjusting the pre-trained model to obtain the identification model according to the converted source data sample and the target data sample; and inputting the converted normal sample and the converted abnormal sample into the identification model to evaluate the performance of the identification model.

### CROSS-REFERENCE TO RELATED APPLICATION

This application claims the priority benefit of Taiwan application serial no. 109128906, filed on Aug. 25, 2020. The entirety of the above-mentioned patent application is hereby incorporated by reference herein and made a part of this specification.

### BACKGROUND

### Technical Field

The disclosure relates to a method and an electronic device for evaluating a performance of an identification model.

### Description of Related Art

When a machine learning algorithm is used to train an identification model, it often takes a lot of time to obtain samples required for training the identification model, and therefore transfer learning is proposed. The transfer learning may use existing identification models pre-trained for specific tasks on other different tasks. For example, an identification model used to identify cars may be fine-tuned into an identification model used to identify ships using transfer learning.

When a performance of the identification model is evaluated, users often need to collect test samples including normal samples and abnormal samples for the identification model in order to calculate an indicator used for evaluating the performance of the identification model. However, collection of the abnormal samples (for example, an appearance image of a flawed object) often takes a lot of time. Taking FIG. 1 as an example, FIG. 1 is a schematic diagram of evaluating a performance of an identification model B using transfer learning. An identification model A pre-trained using multiple triangular images (i.e., source data samples) is used to identify triangular images. Parameters of the pre-trained identification model A may become initial parameters of the identification model B using learning transfer. After using multiple pentagonal images (i.e., target data samples) to perform fine-tuning, the identification model B using transfer learning may be used to identify pentagonal images. In order to evaluate the performance of the identification model B, the user should collect many normal samples and abnormal samples as the test samples of the identification model B, in which the normal samples are, for example, pentagonal images, and the abnormal samples are, for example, non-pentagonal images (for example: hexagonal images). However, collection of the abnormal samples often takes a lot of time.

### SUMMARY

The disclosure provides a method and an electronic device for evaluating a performance of an identification model, which are adapted to evaluate the performance of the identification model without collecting a large amount of test samples.

The disclosure provides a method for evaluating a performance of an identification model. The method includes: obtaining a source data sample, a plurality of test samples, and a target data sample; inputting the plurality of test samples into a pre-trained model trained based on the source data sample to obtain a normal sample and an abnormal sample; converting the source data sample to generate a converted source data sample, converting the normal sample to generate a converted normal sample, and converting the abnormal sample to generate a converted abnormal sample; adjusting the pre-trained model to obtain the identification model according to the converted source data sample and the target data sample; and inputting the converted normal sample and the converted abnormal sample into the identification model to evaluate the performance of the identification model.

The disclosure provides an electronic device for evaluating a performance of an identification model. The electronic includes a processor, a storage medium and a transceiver. The transceiver obtains a source data sample, a plurality of test samples, and a target data sample. The storage medium stores a plurality of modules. The processor is coupled to the storage medium and the transceiver, and accesses and executes the plurality of modules, wherein the plurality of modules include a training module, a test module, a processing module, and an evaluating module. The training module is configured to train a pre-trained model based on the source data sample. The test module is configured to input the plurality of test samples into the pre-trained model to obtain a normal sample and an abnormal sample. The processing module is configured to convert the source data sample, the normal sample and the abnormal sample to respectively generate a converted source data sample, a converted normal sample, and a converted abnormal sample, wherein the training module is further configured to adjust the pre-trained model to obtain the identification model according to the converted source data sample and the target data sample. The evaluating module is configured to input the converted normal sample and the converted abnormal sample into the identification model to evaluate the performance of the identification model.

Based on the above description, according to the disclosure, the user is allowed to complete performance evaluation of the identification model without collecting a large amount of test samples.

### BRIEF DESCRIPTION OF THE DRAWINGS

FIG. 1 is a schematic diagram of evaluating a performance of an identification model using transfer learning.

FIG. 2 is a schematic diagram of an electronic device for evaluating a performance of an identification model according to an embodiment of the disclosure.

FIG. 3 is a schematic diagram of evaluating a performance of an identification model using transfer learning according to an embodiment of the disclosure.

FIG. 4 is a flowchart of a method for evaluating a performance of an identification model according to an embodiment of the disclosure.

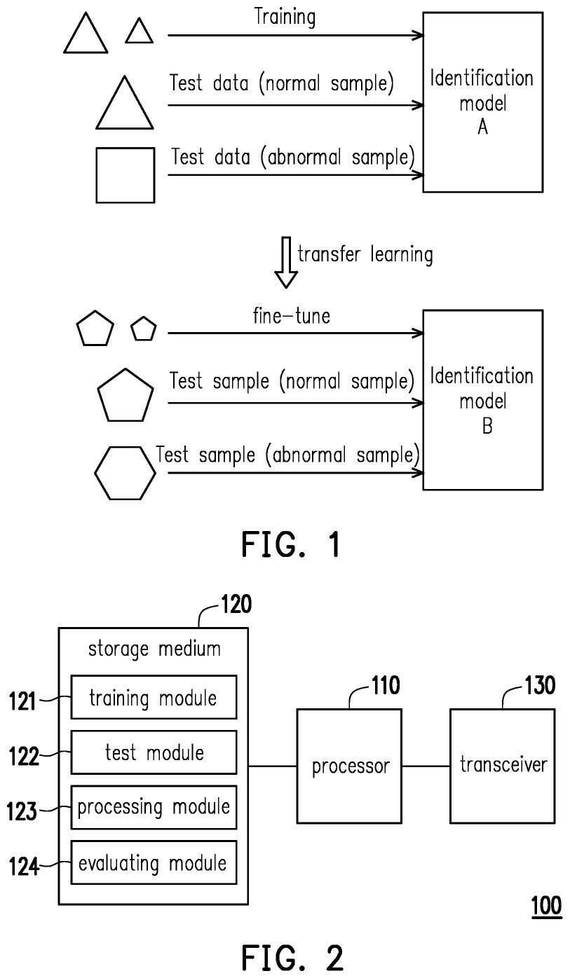

### DESCRIPTION OF THE EMBODIMENTS

FIG. 2 is a schematic diagram of an electronic device 100 for evaluating a performance of an identification model according to an embodiment of the disclosure. The electronic device 100 may include a processor 110, a storage medium 120 and a transceiver 130.

The processor 110 is, for example, a central processing unit (CPU), or other programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA) or other similar components or a combination of the above components. The processor 110 is coupled to the storage medium 120 and the transceiver 130, and accesses and executes a plurality of modules and various applications stored in the storage medium 120.

The storage medium 120 is, for example, any type of a fixed or removable random access memory (RAM), a read-only memory (ROM), a flash memory, a hard disk (HDD), a solid state drive (SSD) or a similar component or a combination of the above components, and is used to store a plurality of modules or various applications that may be executed by the processor 110. In the embodiment, the storage medium 120 may store multiple modules including a training module 121, a test module 122, a processing module 123, and an evaluating module 124, and functions thereof are to be described later. In an embodiment, the training module 121, the test module 122, the processing module 123, and the evaluating module 124 modules may be implemented broadly to software components, hardware components, or firmware components capable of performing specified operations. For example, the software components may include Java, Python, Matlab, c and the like; the hardware components may include an Application Specific Integrated Circuit (ASIC) and a Field Programmable Gate Array (FPGA) device.

The transceiver 130 transmits and receives signals in a wireless or wired manner. The transceiver 130 may also perform operations such as low noise amplification, impedance matching, frequency blending, up or down frequency conversion, filtering, amplification, and the like.

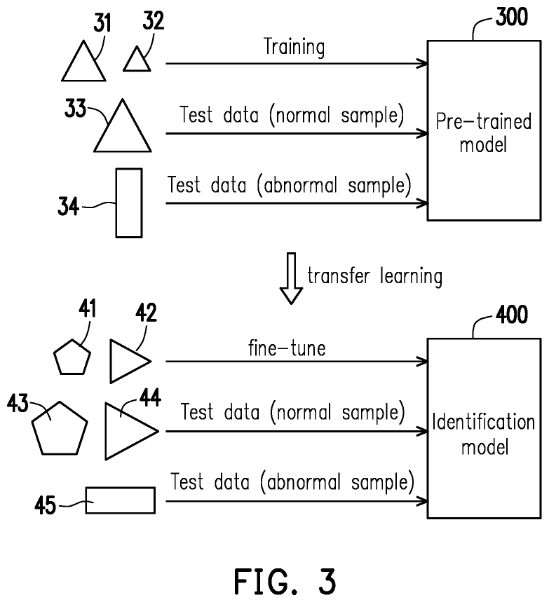

FIG. 3 is a schematic diagram of evaluating a performance of an identification model 400 using transfer learning according to an embodiment of the disclosure. Referring to FIG. 2 and FIG. 3, the training module 121 may obtain one or more source data samples through the transceiver 130, such as a source data sample 31 and a source data sample 32. The training module 121 may use the source data sample 31 and the source data sample 32 as training data to train a pre-trained model 300. In the embodiment, the source data sample 31 and the source data sample 32 may be triangular images (but the disclosure is not limited thereto). Therefore, the pre-trained model 300 trained by using the source data samples 31 and the source data samples 32 may be used to classify triangular images and non-triangular images.

After the pre-training model 300 is generated, the test module 122 may fine-tune the pre-trained model 300 to generate an identification model 400. To be specific, the training module 121 may obtain one or more target data samples, such as a target data sample 41, through the transceiver 130. In the embodiment, the target data sample 41 may be a pentagonal image (but the disclosure is not limited thereto). Therefore, the identification model 400 trained by using the target data sample 41 may be used to identify pentagonal images. Then, the test module 122 may use the source data sample 31 and the target data sample 41 to adjust or fine-tune the pre-trained model 300 to generate the identification model 400. However, using the source data sample 31 to fine-tune the pre-trained model 300 may result in poor performance of the identification model 400 due to overfitting.

Therefore, the processing module 123 may first convert the source data sample 31 into a converted source data sample 42. Then, the training module 121 may use the converted source data sample 42 and the target data sample 41 to fine-tune the pre-trained model 300 to generate the identification model 400. After the training is completed, the identification model 400 may be used to identify objects of the same type as the target data sample 41. In addition, the identification model 400 may also be used to identify objects of the same type as the converted source data sample 42. Namely, the identification model 400 may be used to classify input images into pentagonal images, triangular images, or other types of images.

In an embodiment, the test module 122 may add a first noise to the source data sample 31 to generate the converted source data sample 42. In an embodiment, the test module 122 may perform a first conversion process on the source data sample 31 to convert the source data sample 31 into the converted source data sample 42. The first conversion process may include but is not limited to at least one of the following: x-axis shearing (shearX), y-axis shearing (shearY), x-axis translation (translateX), y-axis translation (translateY), rotating, left-right flipping (flipLR), up-down flipping (flipUD), solarizing, posterizing, contrast adjusting, brightness adjusting, clarity adjusting, blurring, smoothing, edge crispening, auto contrast adjusting, color inverting, histogram equalization, cutting out, cropping, resizing and synthesis.

After the identification model 400 is generated, the evaluating module 124 may evaluate a performance of the identification model 400. To be specific, the training module 121 may obtain a test sample 43 corresponding to the target data sample 41 through the transceiver 130. In the embodiment, the test sample 43 may be a pentagonal image. The test module 122 may use the test sample 43 to evaluate the performance of the identification model 400.

Generally, test samples of the pre-trained model 300 are relatively easy to collect, and test samples of the identification model 400 are relatively difficult to collect, because the pre-trained model 300 has been used for a long time, so that a large amount of test samples have been collected, comparatively, since the identification model 400 has just been trained, the test samples have not been collected yet. In order to increase a number of the test samples of the identification model 400, the test module 122 may also generate test samples other than the test sample 43 based on the existing samples (for example, the test samples of the pre-trained model 300).

To be specific, the training module 121 may obtain a plurality of test samples of the pre-trained model 300 through the transceiver 130, where the plurality of test samples may include unlabeled normal samples and abnormal samples. The test module 122 may input the plurality of test samples into the pre-trained model 300 to identify whether a type of each of the plurality of test samples is the same as that of the source data sample 31 (or the source data sample 32). If the type of the test sample is the same as the type of the source data sample 31, the test module 122 may determine that the test sample is a normal sample. If the type of the test sample is different from the type of the source data sample 31, the test module 122 may determine that the test sample is an abnormal sample. Accordingly, the pre-trained model 300 may label a plurality of test samples according to the identification results, thereby generating a normal sample 33 and an abnormal sample 34. As shown in FIG. 3, the normal sample 33 is a sample that may be classified into the same type as that of the source data sample 31 (for example, a triangular image), and the abnormal sample 34 is a sample that may be classified into a different type from that of the source data sample 31 (for example: a rectangular image). In this way, the pre-trained model 300 may automatically generate a large number of labeled normal samples and abnormal samples.

The test module 122 may convert the normal sample 33 into a converted normal sample 44, and may convert the abnormal sample 34 into a converted abnormal sample 45. Then, the evaluating module 124 may use the test sample 43, the converted normal sample 44, and the converted abnormal sample 45 to evaluate the performance of the identification model 400.

In an embodiment, the test module 122 may add a second noise to the normal sample 33 to generate the converted normal sample 44, where the second noise may be the same as the first noise. In an embodiment, the test module 122 may perform a second conversion process on the normal sample 33 to convert the normal sample 33 into the converted normal sample 44, where the second conversion process may be the same as the first conversion process.

In an embodiment, the test module 122 may add a third noise to the abnormal sample 34 to generate the converted abnormal sample 45, where the third noise may be the same as the first noise. In an embodiment, the test module 122 may perform a third conversion process on the abnormal sample 34 to convert the abnormal sample 34 into the converted abnormal sample 45, where the third conversion process may be the same as the first conversion process.

The evaluating module 124 may input the test sample 43, the converted normal sample 44, and the converted abnormal sample 45 into the identification model 400 to generate a receiver operating characteristic (ROC) curve of the identification model 400. The evaluating module 124 may evaluate the performance of the identification model 400 and generate a performance report according to the ROC curve. The evaluating module 124 may output the performance report through the transceiver 130. For example, the evaluating module 124 may output the performance report to a display through the transceiver 130, so as to display the performance report through the display for the user to read.

If the evaluating module 124 determines that the performance of the identification model 400 is greater than or equal to a threshold, the evaluating module 124 may determine that the training process of the identification model 400 has been completed, in which the threshold may be defined by the user according to actual requirements. On the other hand, if it is determined that the performance of the identification model 400 is less than the threshold, the training module 121 may fine-tune the identification model 400 again to improve the identification model 400. To be specific, the training module 121 may use the target data sample 41 and the converted source data sample 42 to fine-tune the identification model 400 again to update the identification model 400. The training module 121 may repeatedly update the identification model 400 until the performance of the updated identification model 400 is greater than the threshold.

The completed identification model 400 may be used to identify a type of an input image. In the embodiment, the identification model 400 may be used to identify pentagonal images, triangular images, and other types of images. The test module 122 may output the identification model 400 to an external electronic device through the transceiver 130 for the use by the external electronic device.

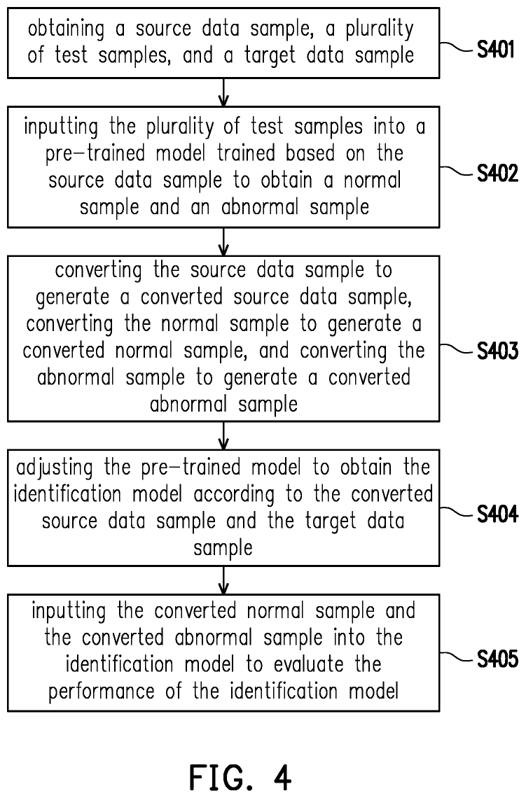

FIG. 4 is a flowchart of a method for evaluating a performance of an identification model according to an embodiment of the disclosure, where the method may be implemented by the electronic device 100 as shown in FIG. 2. In step S401, a source data sample, a plurality of test samples, and a target data sample are obtained. In step S402, the plurality of test samples are inputted into a pre-trained model trained based on the source data sample to obtain a normal sample and an abnormal sample. In step S403, the source data sample is converted to generate a converted source data sample, the normal sample is converted to generate a converted normal sample, and the abnormal sample is converted to generate a converted abnormal sample. In step S404, the pre-trained model is adjusted according to the converted source data sample and the target data sample to obtain an identification model. In step S405, the converted normal sample and the converted abnormal sample are inputted into the identification model to evaluate a performance of the identification model.

In summary, the disclosure may generate an identification model according to a pre-trained model using transfer learning and a fine-tuning process, and may use the pre-trained model to automatically generate test samples used for performing performance evaluation of the identification model. Therefore, regardless of whether task domains of the identification model and the pre-trained model are the same, the user does not need to spend time collecting test samples corresponding to the identification model. Therefore, after obtaining the pre-trained model and the test samples corresponding to the pre-trained model, the user may quickly develop a variety of identification models for tasks of different fields based on the pre-trained model.

What is claimed is:

1. A method for evaluating a performance of an identification model, comprising:
obtaining a source data sample, a plurality of test samples, and a target data sample;
inputting the plurality of test samples into a pre-trained model to obtain a normal sample and an abnormal sample, wherein the pre-trained model is trained based on the source data sample;
converting the source data sample to generate a converted source data sample, converting the normal sample to generate a converted normal sample, and converting the abnormal sample to generate a converted abnormal sample;
adjusting the pre-trained model to obtain the identification model according to the converted source data sample and the target data sample; and
inputting the converted normal sample and the converted abnormal sample into the identification model to evaluate the performance of the identification model.

2. The method for evaluating the performance of the identification model as claimed in claim 1, wherein the step of converting the source data sample to generate the converted source data sample comprises:
adding a noise to the source data sample to generate the converted source data sample.

3. The method for evaluating the performance of the identification model as claimed in claim 1, wherein the step of converting the source data sample to generate the converted source data sample comprises: performing a conversion process on the source data sample to convert the source data sample into the converted source data sample, wherein the conversion process comprises at least one of the following:
x-axis shearing, y-axis shearing, x-axis translation, y-axis translation, rotating, left-right flipping, up-down flipping, solarizing, posterizing, contrast adjusting, brightness adjusting, clarity adjusting, blurring, smoothing, edge crispening, auto contrast adjusting, color inverting, histogram equalization, cutting out, cropping, resizing and synthesis.

4. The method for evaluating the performance of the identification model as claimed in claim 3, wherein the step of converting the normal sample to generate the converted normal sample, and converting the abnormal sample to generate the converted abnormal sample comprises: performing the conversion process on the normal sample to generate the converted normal sample, and performing the conversion process on the abnormal sample to generate the converted abnormal sample.

5. The method for evaluating the performance of the identification model as claimed in claim 1, wherein the step of inputting the converted normal sample and the converted abnormal sample into the identification model to evaluate the performance of the identification model comprises:
inputting the converted normal sample and the converted abnormal sample into the identification model to generate a receiver operating characteristic curve; and
evaluating the performance according to the receiver operating characteristic curve.

6. The method for evaluating the performance of the identification model as claimed in claim 1, further comprising: in response to the performance being less than a threshold, fine-tuning the identification model according to the converted source data sample and the target data sample.

7. An electronic device for evaluating a performance of an identification model, comprising:
a transceiver, obtaining a source data sample, a plurality of test samples, and a target data sample;
a storage medium, storing a plurality of modules; and
a processor, coupled to the storage medium and the transceiver, and accessing and executing the plurality of modules, wherein the plurality of modules comprise:
a training module configured to train a pre-trained model based on the source data sample;
a test module configured to input the plurality of test samples into the pre-trained model to obtain a normal sample and an abnormal sample;
a processing module configured to convert the source data sample, the normal sample and the abnormal sample to respectively generate a converted source data sample, a converted normal sample and a converted abnormal sample, wherein the training module is further configured to adjust the pre-trained model to obtain the identification model according to the converted source data sample and the target data sample; and
an evaluating module configured to input the converted normal sample and the converted abnormal sample into the identification model to evaluate the performance of the identification model.

8. The electronic device as claimed in claim 7, wherein the test module adds a noise to the source data sample to generate the converted source data sample.

9. The electronic device as claimed in claim 7, wherein the test module performs a conversion process on the source data sample to convert the source data sample into the converted source data sample, wherein the conversion process comprises at least one of the following:
x-axis shearing, y-axis shearing, x-axis translation, y-axis translation, rotating, left-right flipping, up-down flipping, solarizing, posterizing, contrast adjusting, brightness adjusting, clarity adjusting, blurring, smoothing, edge crispening, auto contrast adjusting, color inverting, histogram equalization, cutting out, cropping, resizing and synthesis.

10. The electronic device as claimed in claim 9, wherein the test module performs the conversion process on the normal sample to generate the converted normal sample, and performs the conversion process on the abnormal sample to generate the converted abnormal sample.

11. The electronic device as claimed in claim 7, wherein the evaluating module inputs the converted normal sample and the converted abnormal sample into the identification model to generate a receiver operating characteristic curve, and evaluates the performance according to the receiver operating characteristic curve.

12. The electronic device as claimed in claim 7, wherein in response to the performance being less than a threshold, the test module fine-tunes the identification model according to the converted source data sample and the target data sample.
